(19) United States
(12) Patent Application Publication
(10) Pub. No.: US 2015/0121312 A1
(43) Pub. Date: Apr. 30, 2015

(54) SHORTCUT OPERATION METHOD AND DEVICE, MOBILE TERMINAL AND STORAGE MEDIUM

(71) Applicant: Tencent Technology (Shenzhen) Company Limited, Guangdong (CN)

(72) Inventor: Li LI, Guangdong (CN)

(21) Appl. No.: 14/593,027

(22) Filed: Jan. 9, 2015

Related U.S. Application Data
(63) Continuation of application No. PCT/CN2013/078692, filed on Jul. 2, 2013.

(30) Foreign Application Priority Data
Jul. 11, 2012 (CN) 201210239270.9

(51) Int. Cl. G06F 3/0481; G06F 3/0484; G06F 3/0488

(52) U.S. Cl. CPC G06F 3/04817; G06F 3/0488; G06F 3/04842
USPC 715/847

(57) ABSTRACT

The present invention relates to the field of Internet mobile terminals. Disclosed are a quick operation method and device and a mobile terminal. The method comprises: displaying preview content on a screen lock interface, wherein the preview content comprises at least one of the text information, graphics information, emotion information, incoming call information and geographical information; receiving operation of a user on the preview content; and processing the preview content according to the operation, wherein the processing comprises marking as being read and marking as at least one of the states of being collected, saved, deleted, reported, replied, played and updated. The present invention directly displays the preview content on the screen lock interface and directly operates the preview content, to solve the problem in the existing quick operation method that operation needs to be performed multiple times and the whole interacting process is rather complex.

### CROSS-REFERENCE TO RELATED APPLICATION

This application claims priority to and is a continuation application of PCT/CN2013/078692, filed on Jul. 2, 2013 and entitled “SHORTCUT OPERATION METHOD AND DEVICE, MOBILE TERMINAL AND STORAGE MEDIUM”, which claims the benefit of Chinese Patent Application No. 201210239270.9 filed on Jul. 11, 2012 by Tencent Technology (Shenzhen) Co., Ltd., entitled “SHORTCUT OPERATION METHOD AND DEVICE AND MOBILE TERMINAL”, which are incorporated herein by reference in their entirety.

### TECHNICAL FIELD

The present disclosure relates to the field of mobile terminals over the Internet, and in particular, to a shortcut operation method and device, a mobile terminal and a storage medium.

### BACKGROUND

With the development of the Internet and wireless communication technique, mobile terminals such as smartphones and tablet PCs have become the most prevalent devices in daily life. A design for quick and humanized interaction between the mobile terminals and users is an important subject researched by modern terminal equipment manufactures.

Applications such as a short message service, a phone call, a browser and a er in the mobile terminals are most commonly used by the users. Taking a touch screen smart phone as an example of one of the mobile terminals, when the user receives a short message, usual operations of the user include that: the user first touches a key such as a power button or a main menu to invoke a touch screen of the mobile terminal, at this time, a lock screen interface, which is an interface displayed on the touch screen that is locked in standby status of the mobile terminal to avoid a misoperation on the mobile terminal, is generally displayed on the touch screen of the mobile terminal; the user then unlocks the lock screen interface by a slide operation or inputting a password, at this moment, the mobile terminal displays the icon or interface of the short message service application; and the user clicks the icon or interface of the short message service application for further operating, such as the received short message, and marking the short message as read status automatically or manually.

As for the existing mobile terminals described above, inventors found the following problems in the prior art that: the user needs to perform numerous operations from receiving a short message to marking the short message as read status, thus the whole interactive process is complex, and hence is not quick and humanized.

### SUMMARY

In order to solve the problem of the complex interactive process caused by numerous operations required by the existing shortcut operation method, an embodiment of the present disclosure provides a shortcut operation method and device, a mobile terminal and a storage medium. The technical solution is as follows.

One aspect, an embodiment of the present disclosure provides a shortcut operation method including:

displaying preview contents on a lock screen interface;

receiving an operation conducted by a user on the preview contents; and

processing the preview contents according to the operation, wherein, the processing comprises at least one of marking the preview contents as read status, marking the preview contents as collected status, saving the preview contents, deleting the preview contents, reporting the preview contents, replying to the preview contents, playing the preview contents and updating.

At another aspect, an embodiment of the present disclosure provides a shortcut operation device, comprising:

a preview displaying module configured to display preview contents on a lock screen interface, wherein the preview contents include at least one of text information, graphics information, expression information, incoming call information and geographical information;

an operation receiving module configured to receive an operation conducted by a user on the preview contents; and

an operation processing module configured to process the preview contents according to the operation, wherein, the process includes at least one of marking the preview contents as read status, marking the preview contents as collected status, saving the preview contents, deleting the preview contents, reporting the preview contents, replying to the preview contents, playing the preview contents and updating.

At yet another aspect, an embodiment of the present disclosure provides a mobile terminal comprising the anyone of the shortcut operation device of the above-mentioned solutions.

At yet another aspect, an embodiment of the present disclosure provides a storage media containing one or more computer-executable instructions, where the computer-executable instructions are configured to perform the shortcut operation method including steps of:

displaying preview contents on a lock screen interface;

receiving the operation conducted by a user on the preview contents; and

processing the preview contents according to the operation, where the processing includes at least one of marking the preview contents as read status, marking the preview contents as collected status, saving the preview contents, deleting the preview contents, reporting the preview contents, replying to the preview contents, playing the preview contents and updating.

In the shortcut operation device provided by the present embodiment, the preview contents are displayed on the lock screen interface and may be directly operated, so that the problem of the complex interactive process caused by numerous operations required by the existing shortcut operation method is solved, therefore, an effect of operations such as marking the SMS as read status or directly deleting a microblog post in three steps is achieved.

### BRIEF DESCRIPTION OF THE DRAWINGS

In order to more clearly illustrate the technical solutions of the embodiments of the present disclosure, the drawings used for the description of the embodiments will be briefly introduced below. However, the drawings in the description below illustrate only some embodiments of the present disclosure, and modifications and substitutions can be made to these drawings by those ordinary skilled in the art without creative work.

FIG. 1 is a flow chart of a shortcut operation method provided by a first embodiment of the present disclosure.

FIG. 2 is a flow chart of a shortcut operation method provided by a second embodiment of the present disclosure.

FIG. 3A to FIG. 3B are schematic diagrams showing the implementation of the shortcut operation method provided by the third embodiment of the present disclosure.

FIG. 4 is a block diagram illustrating a structure of a shortcut operation device provided by a third embodiment of the present disclosure.

FIG. 5 is a block diagram illustrating a structure of a shortcut operation device provided by a fourth embodiment of the present disclosure.

FIG. 6 is another block diagram illustrating a structure of a preview displaying module provided by the fourth embodiment of the present disclosure.

FIG. 7 is a block diagram illustrating a structure of a content generating unit provided by the fourth embodiment of the present disclosure.

FIG. 8 is a block diagram illustrating a structure of an operation receiving module provided by the fourth embodiment of the present disclosure.

### DETAILED DESCRIPTION OF THE EMBODIMENTS

To make the purposes, technical solutions and advantages of the present disclosure more clear, the present disclosure will be further illustrated below in conjunction with the drawings and specific embodiments in the specification.

### First Embodiment

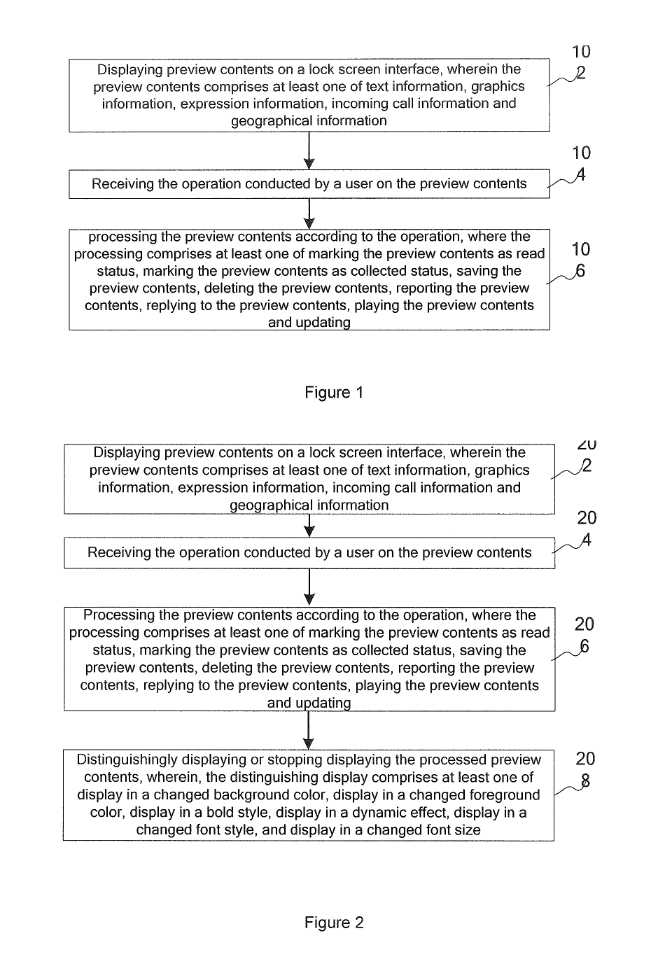

Referring to FIG. 1 which is a flow chart of a shortcut operation method provided by a first embodiment of the present disclosure, the shortcut operation method may be applicable to mobile terminals such as smartphones and tablet PCs. The shortcut operation method may include Step 102, Step 104 and Step 106 below.

At Step 102, preview contents are displayed in a lock screen interface. The preview contents include at least one of text information, graphics information, expression information, incoming call information and geographical information.

When the lock screen interface is invoked, the preview contents are displayed on the lock screen interface by the mobile terminal. The preview contents may include one or more of text information, graphics information, expression information, incoming call information and geographical information. For example, the preview contents may be short message service (SMS) information, microblog information or news information newly received by the mobile terminal.

At Step 104, an operation of a user on the preview contents is received.

The user is allowed to perform the operation on the preview contents, and the operation may be any one of hand gestures such as single-click, double-click and slide. The hand gestures may be contact gestures or non-contact gestures. If the preview contents include a plurality of contents, the user may perform the operation on any one of the contents. For example, if the preview contents include three pieces of SMS information, the user may perform a slide operation on one of these pieces of SMS information.

At Step 106, the preview contents are processed according to the operation. The process includes at least one of marking the preview contents as read status, marking the preview contents as collected status, saving, deleting, reporting, replying, playing and updating.

When receiving the operation from the user, the mobile terminal may process the preview contents or one of the preview contents, and the process may include at least one of marking the preview contents as read status, marking the preview contents as collected status, saving, deleting, reporting, replying, playing and updating. For example, if the user performs a slide operation on a piece of SMS information, the mobile terminal may mark the SMS information as read status.

As such, in the shortcut operation method provided by the present embodiment, the preview contents are displayed on the lock screen interface and may be directly operated, so that the problem of the complex interactive process caused by numerous operations required by the existing shortcut operation method is solved, therefore, an effect of operations such as marking the SMS as read status or directly deleting a microblog post in three steps is achieved.

### Second Embodiment

Referring to FIG. 2 which is a flow chart of a shortcut operation method provided by a second embodiment of the present disclosure, and the shortcut operation method is applicable to the mobile terminals such as smart phones and tablet PCs. The shortcut operation method may include Step 202, Step 204, Step 206 and Step 208.

At Step 202, preview contents are displayed on a lock screen interface. The preview contents include at least one of text information, graphics information, expression information, incoming call information and geographical information.

When the lock screen interface is invoked, the preview contents are displayed on the lock screen interface by the mobile terminal. Depending on the implementations, the preview contents may be displayed on the lock screen interface by the mobile terminal in the following two manners.

The first implementation manner is that the preview contents are directly displayed and includes the following steps.

First, at least one of the text information, the graphics information, the expression information, the incoming call information and the geographical information is received.

The mobile terminal may receive the text information such as SMS information, or microblog information. The mobile terminal may also receive the graphics information such as a multimedia message, or news information. The mobile terminal may also receive the expression information such as expression information in an instant messaging program. The mobile terminal may also receive the incoming call information such as an incoming call number of the current incoming call. The mobile terminal may also receive the geographical information such as real-time location information of a navigation program. Depending on different application scenarios, the mobile terminal may receive one or more of the above contents.

Secondly, the preview contents are generated according to the received contents.

In an example where the contents received by the mobile terminal are SMS information, the preview contents are generated by the mobile terminal from the received contents. The specific process of the generation may include: creating a new list control as a preview control; and sequentially loading the received n contents to the preview control as the preview contents, where n is an integer larger than or equal to 1. The list control may be a Listview control in the Android operating system. The received n contents may be the latest 3 pieces of unread SMS information in the short message database of the mobile terminal.

Thirdly, when the lock screen interface is invoked, the preview contents are displayed on the lock screen interface.

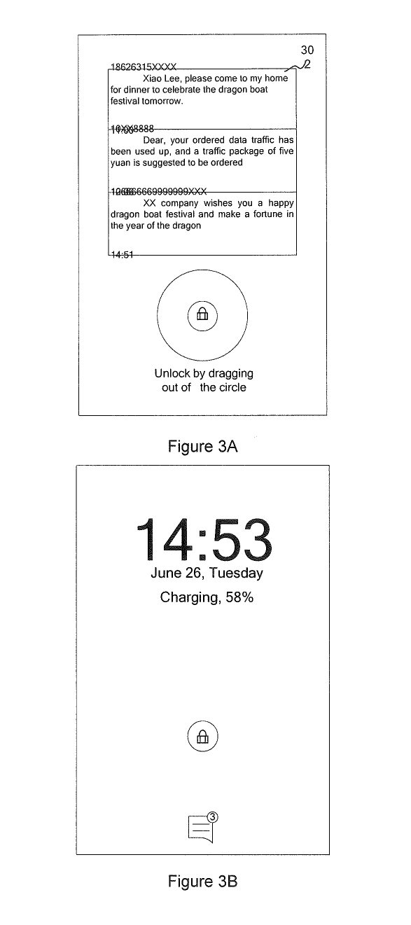

After the user presses a power button or a main menu of the mobile terminal, the mobile terminal invokes the lock screen interface for displaying. At this moment, the preview contents are displayed on the lock screen interface by a mobile terminal, for example, the preview contents are the latest 3 pieces of unread SMS information, as shown in FIG. 3A.

The second implementation manner is that the preview contents are displayed according to the user's operation and includes the following steps.

First, at least one of the text information, the graphics information, the expression information, the incoming call information and the geographical information is received.

Secondly, the preview contents are generated from the received contents.

The above two steps are the same as the first and second steps of the first implementation manner.

Thirdly, when the lock screen interface is invoked, an icon or area corresponding to the preview contents is displayed on the lock screen interface.

The second implementation manner differs from the first implementation manner in that: after the user presses a power button or a main menu of the mobile terminal, the mobile terminal invokes the lock screen interface for displaying, but the icon or area corresponding to the preview contents is displayed on the lock screen interface by the mobile terminal at this moment, for example, if the preview contents are the latest 3 pieces of unread SMS information, a short messaging icon is displayed on the lock screen interface by the mobile terminal, with a number 3 being displayed on the top right corner of the short messaging icon to indicates the presence of 3 pieces of unread SMS information, as shown in FIG. 3B.

Fourthly, when an operation of the user on the icon or area is received, the preview contents are displayed.

When the user clicks or drags the icon or area, the preview contents are displayed by the mobile terminal. For example, after the user clicks the short messaging icon as shown in FIG. 3B, the latest 3 pieces of unread SMS information are displayed by the mobile terminal as shown in FIG. 3A.

At Step 204, the operation of the user on the preview contents is received.

After the preview contents are displayed on the lock screen interface by the mobile terminal, the operation of the user on the preview contents may be received by the mobile terminal. The operation of the user on the preview contents may be any one of hand gestures such as single-click, double-click and slide, where the hand gestures may be contact gestures or non-contact gestures. Again in the example where the preview contents are the latest 3 pieces of unread SMS information, if the user performs a slide operation on the preview contents, then the slide operation of the user on the preview contents is received by the mobile terminal, for example by a specific process including: detecting, by the mobile terminal, a slide event conducted by the user on a certain content displayed in the preview control; determining, by the mobile terminal, whether a slide speed or a slide distance of the slide event is larger than a predetermined threshold; and determining that the operation on the content is received if the slide speed or slide distance is larger than the predetermined threshold.

More specifically, a slide event conducted by the user on an unread short message 302 displayed in the preview control may be detected by the mobile terminal, where the slide event may be an on-Touch-Event in the Android operating system, which may be ACTION-DOWN, ACTION-UP or ACTION-MOVE.

First, when the user performs a slide operation on the unread short message 302, the ACTION-DOWN event indicating the occurrence of the touch event is detected by the mobile terminal, at this moment, the mobile terminal obtains position coordinates of a first touch point on the touch screen touched by a finger of the user, determines whether the preview contents are displayed on the current position of the first touch point, and if the preview contents are not displayed on the current position, the method is completed; and if the preview contents (i.e. the unread short message 302) are displayed on the current position, the method proceeds to the next step.

Then, the mobile terminal stores the preview content currently chosen by the user, and further detects an ACTION-MOVE event to obtain position coordinates of a second touch point touched by the current user.

At last, the mobile terminal detects an ACTION-UP event. If the ACTION-UP event is detected, it is indicated that the finger of the user has removed from the second touch point, a moving speed of the user finger and a displacement in an X-axis direction are calculated according to the position coordinates of the first touch point, the position coordinates of the second touch point and the time taken for moving from the first touch point to the second touch point. If any one of the above moving speed and the displacement is larger than a predetermined threshold, the mobile terminal determines that the slide operation of the user on the unread short message 302 is received.

At Step 206, the preview contents are processed according to the operation. The process includes at least one of marking the preview contents as read status, marking the preview contents as collected status, saving, deleting, reporting, replying, playing and updating.

After the operation of the user on the preview contents is received by the mobile terminal, the preview contents are processed by the mobile terminal according to the operation. For example, if a slide operation is performed by the user on the unread short message 302, the mobile terminal may mark the unread short message 302 as read status. Different presettings may be made correspondingly for different application scenarios, as such, different processes may be made by the mobile terminal to the respective preview contents, for example, if the preview content is SMS information or microblog information, the preview content may be marked by the mobile terminal as read status or collected status, saved, deleted or replied. If the preview content is the expression information or the graphics information, the preview content may be saved, deleted or played by the mobile terminal. If the preview content is the incoming call information (i.e. one kind of text information), a mobile number in the incoming call information is stored in the mobile terminal as a contact, a crank call to be reported or a fraud call to be reported. If the preview content is software updating information (i.e. one of text information), a software update operation may be performed in the mobile terminal.

At Step 208, the processed preview contents are displayed distinguishingly or not displayed any more. The distinguishing display includes at least one of display in a changed background color, display in a changed foreground color, display in a bold style, display in a dynamic effect, display in a changed font style, and display in a changed font size.

After the preview contents have been processed by the mobile terminal, the processed preview contents may be displayed distinguishingly or not displayed any more by the mobile terminal. For example, after marking a piece of SMS information as read status, the mobile terminal changes the background color of the list item containing the SMS information from blue to gray; after collecting a piece of news information, the mobile terminal changes the foreground color of the text of the news information from black to blue and display the text in a bold style; after deleting a piece of expression information, the mobile terminal first displays the expression information in the dynamic effect of shaking, and then does not display the expression information any more; and after storing the mobile number in a piece of incoming call information, the mobile terminal changes the font style and the font size of the mobile number for displaying; and so on, which are not described in an exhausted way.

As such, in the shortcut operation method provided by the present embodiment, the preview contents are displayed on the lock screen interface and may be directly operated, so that the problem of the complex interactive process caused by numerous operations required by the existing shortcut operation method is solved, therefore, an effect of operations such as marking the SMS as read status or directly deleting a microblog post in three steps is achieved. Further, the user can easily distinguish the processed preview contents from unprocessed preview contents by distinguishingly displaying the processed preview contents or stopping displaying the processed preview contents any more.

### Third Embodiment

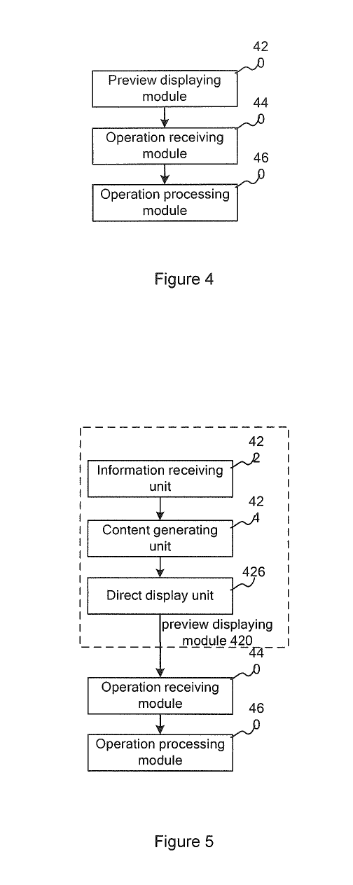

Referring to FIG. 4 which is a block diagram illustrating a structure of a shortcut operation device provided by the third embodiment. The shortcut operation device may be a part of the mobile terminal or the mobile terminal per se. The shortcut operation device may include a preview displaying module 420, an operation receiving module 440 and an operation processing module 460.

The preview displaying module 420 is configured to display preview contents on a lock screen interface. The preview contents include at least one of text information, graphics information, expression information, incoming call information and geographical information.

The operation receiving module 440 is configured to receive the operation made by the user on the preview contents displayed by the preview displaying module 420.

The operation processing module 460 is configured to process the preview contents according to the operation received by the operation receiving module 440. Such process includes at least one of marking the preview contents as read status, marking the preview contents as collected status, saving the preview contents, deleting the preview contents, reporting the preview contents, replying to the preview contents, playing the preview contents and updating.

As such, in the shortcut operation device provided by the present embodiment, the preview contents are displayed on the lock screen interface and may be directly operated, so that the problem of the complex interactive process caused by numerous operations required by the existing shortcut operation method is solved, therefore, an effect of operations such as marking the SMS as read status or directly deleting a microblog post in three steps is achieved.

### Fourth Embodiment

Referring to FIG. 5 which is a block diagram illustrating a structure of a shortcut operation device provided by the fourth embodiment. The shortcut operation device may be a part of the mobile terminal or the mobile terminal per se. The shortcut operation device may include a preview displaying module 420, an operation receiving module 440, an operation processing module 460 and a distinguishingly displaying module 480.

The preview displaying module 420 is configured to display preview contents on a lock screen interface. The preview contents include at least one of text information, graphics information, expression information, incoming call information and geographical information.

The operation receiving module 440 is configured to receive an operation conducted by a user on the preview contents displayed by the preview displaying module 420.

The operation processing module 460 is configured to process the preview contents according to the operation received by the operation receiving module 440. Such process includes at least one of marking the preview contents as read status, marking the preview contents as collected status, saving the preview contents, deleting the preview contents, reporting the preview contents, replying to the preview contents, playing the preview contents and updating.

The distinguishingly displaying module 480 is configured to distinguishingly display or to stop displaying the preview contents processed by the operation processing module 460. The distinguishing display includes at least one of display in a changed background color, display in a changed foreground color, display in a bold style, display in a dynamic effect, display in a changed font style, and display in a changed font size.

Specifically, the preview displaying module 420 specifically includes an information receiving unit 422, a content generating unit 424 and a direct display unit 426. The information receiving unit 422 is configured to receive at least one of text information, graphics information, expression information, incoming call information and geographical information. The content generating unit 424 is configured to generate the preview contents according to the contents received by the information receiving unit 422. The direct display unit 426 is configured to display the preview contents generated by the content generating unit 424 on the lock screen interface when the lock screen interface is invoked.

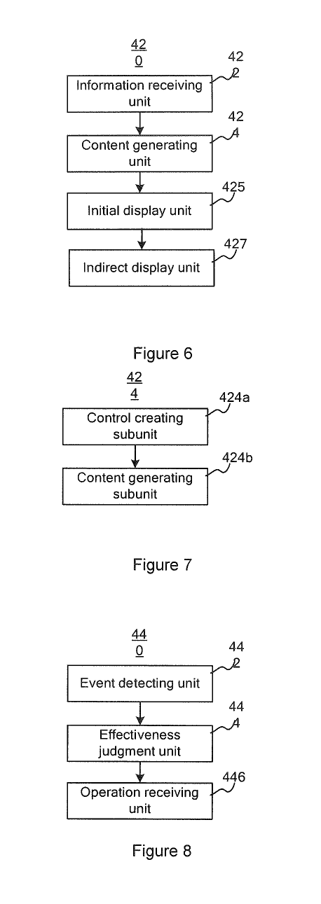

Alternatively, the preview displaying module 420 specifically includes the information receiving unit 422, the content generating unit 424, an initial display unit 425 and an indirect display unit 427 as shown in FIG. 6. The information receiving unit 422 is configured to receive at least one of text information, graphics information, expression information, incoming call information and geographical information. The content generating unit 424 is configured to generate the preview contents according to the contents received by the information receiving unit 422. The initial display unit 425 is configured to display an icon or area corresponding to preview contents on the lock screen interface when the lock screen interface is invoked. The indirect display unit 427 is configured to display the preview contents generated by the content generating unit 424 when the operation conducted by the user on the icon or area displayed by the initial display unit 425 is received.

Further, the content generating unit 424 specifically includes a control creating subunit 424a and a content generating subunit 424b as shown in FIG. 7. The control creating subunit 424a is configured to create a list control as a preview control. The content generating subunit 424b is configured to successively load n contents received by the control creating subunit 424a into the preview control as preview contents, where n is an integer larger than or equal to 1.

The operation receiving module 440 may include an event detecting unit 442, an effectiveness judgment unit 444 and an operation receiving unit 446 as shown in FIG. 8. The event detecting unit 442 is configured to detect a slide event conducted by the user on a certain content displayed in the preview control. The effectiveness judgment unit 444 is configured to determine whether a slide speed or a slide distance of the slide event is larger than a predetermined threshold. The operation receiving unit 446 is configured to confirm receipt of the operation conducted on the content if the effectiveness judgment unit 444 determines that the slide speed or slide distance of the slide event is larger than the predetermined threshold.

The operation receiving module 440 is further configured to receive any one of hand gestures such as single-click, double-click or slide. The hand gestures may be contact gestures or non-contact gestures.

As such, in the shortcut operation device provided by the present embodiment, the preview contents are displayed on the lock screen interface and may be directly operated, so that the problem of the complex interactive process caused by numerous operations required by the existing shortcut operation method is solved, therefore, an effect of operations such as marking the SMS as read status or directly deleting a microblog post in three steps is achieved. Further, the user can easily distinguish the processed preview contents from unprocessed preview contents by distinguishingly displaying the processed preview contents or stopping displaying the processed preview contents any more.

It should be noted that the shortcut operation device provided by the above embodiment is illustrated by taking the divided various function modules as an example. In practice, the above functions may be implemented by different function modules as needed, i.e. an inner structure of the device may be divided into different function modules to implement all of or a part of the functions as mentioned above. In addition, the shortcut operation device and the shortcut operation method share the same concept, and for the specific implementation of the shortcut operation device process, reference may be made to the description of the method embodiment, which will not be repeated here.

One or more storage media containing computer-executable instructions are provided by an embodiment of the present disclosure, where the computer-executable instructions are configured to perform the shortcut operation method including steps of:

displaying preview contents on a lock screen interface;

receiving the operation conducted by a user on the preview contents; and

processing the preview contents according to the operation, where the processing includes at least one of marking the preview contents as read status, marking the preview contents as collected status, saving the preview contents, deleting the preview contents, reporting the preview contents, replying to the preview contents, playing the preview contents and updating.

The preview contents include at least one of text information, graphics information, expression information, incoming call information and geographical information.

The sequence numbers of the above embodiments are just used for the description, but do not indicate the superiority of the embodiments.

A person skilled in the art can understand that all of or a part of the steps in the above embodiments may be implemented by hardware merely or related hardware operated by programs. The programs may be stored in a computer readable storage medium, which may be a read-only memory, a random access memory, a flash memory, a disk or a compact disk, etc.

The above description only shows some embodiments of the present disclosure, rather than limiting the scope of the present disclosure. Various modifications, equivalent substitutions and improvements made to the embodiments in light of spirit and principle of the present disclosure without departing from the disclosures of the invention all fall into the protection scope of the invention.

What is claimed is:

1. A shortcut operation method, comprising:
displaying preview contents on a lock screen interface;
receiving an operation conducted by a user on the preview contents; and
processing the preview contents according to the operation, wherein, the processing comprises at least one of marking the preview contents as read status, marking the preview contents as collected status, saving the preview contents, deleting the preview contents, reporting the preview contents, replying to the preview contents, playing the preview contents and updating.

2. The method according to claim 1, wherein, the preview contents comprise at least one of text information, graphics information, expression information, incoming call information and geographical information.

3. The method according to claim 2, wherein, the displaying the preview contents on the lock screen interface comprises:
receiving at least one of the text information, the graphics information, the expression information, the incoming call information and the geographical information;
generating the preview contents from the at least one of the text information, the graphics information, the expression information, the incoming call information and the geographical information as received; and
displaying the preview contents on the lock screen interface when the lock screen interface is invoked.

4. The method according to claim 2, wherein, the displaying the preview contents on the lock screen interface comprises:
receiving at least one of the text information, the graphics information, the expression information, the incoming call information and the geographical information;
generating the preview contents from the at least one of the text information, the graphics information, the expression information, the incoming call information and the geographical information as received;
displaying an icon or area corresponding to the preview contents on the lock screen interface when the lock screen interface is invoked; and
displaying the preview contents when the operation conducted by the user on the icon or area is received.

5. The method according to claim 3, wherein, the generating the preview contents from the at least one of the text information, the graphics information, the expression information, the incoming call information and the geographical information as received comprises:
creating a list control as a preview control;
sequentially loading received n contents to the preview control as the preview contents, wherein n is an integer larger than or equal to 1;
wherein the receiving the operation conducted by the user on the preview contents comprises:
detecting a slide event of the user on a certain content displayed in the preview control;
determining whether a slide speed or a slide distance of the slide event is larger than a predetermined threshold; and
determining that the operation conducted on the content is received if the slide speed or the slide distance is larger than the predetermined threshold.

6. The method according to claim 4, wherein, the generating the preview contents from the at least one of the text information, the graphics information, the expression information, the incoming call information and the geographical information as received comprises:
creating a list control as a preview control;
sequentially loading received n contents to the preview control as the preview contents, wherein n is an integer larger than or equal to 1;
wherein the receiving the operation conducted by the user on the preview contents comprises:
detecting a slide event of the user on a certain content displayed in the preview control;
determining whether a slide speed or a slide distance of the slide event is larger than a predetermined threshold; and
determining that the operation conducted on the content is received if the slide speed or the slide distance is larger than the predetermined threshold.

7. The method according to claim 1, wherein, the receiving the operation conducted by the user on the preview contents comprises:
receiving any of hand gestures comprising single-click, double-click and slide of the user on the preview contents.

8. The method according to claim 1, wherein, after processing the preview contents according to the operation, the method further comprises:
distinguishingly displaying or stopping displaying the processed preview contents, wherein, the distinguishing display comprises at least one of display in a bold style, display in a dynamic effect, display in a changed font style, and display in a changed font size.

9. A shortcut operation device, comprising:
a preview displaying module configured to display preview contents on a lock screen interface;
an operation receiving module configured to receive an operation conducted by a user on the preview contents; and
an operation processing module configured to process the preview contents according to the operation, wherein, the process comprises at least one of marking the preview contents as read status, marking the preview contents as collected status, saving the preview contents, deleting the preview contents, reporting the preview contents, replying to the preview contents, playing the preview contents and updating.

10. The device according to claim 9, wherein, the preview contents comprises at least one of text information, graphics information, expression information, incoming call information and geographical information.

11. The device according to claim 10, wherein, the preview displaying module specifically comprises an information receiving unit, a content generating unit and a direct display unit,
the information receiving unit is configured to receive at least one of the text information, the graphics information, the expression information, the incoming call information and the geographical information;
the content generating unit is configured to generate the preview contents from the at least one of the text information, the graphics information, the expression information, the incoming call information and the geographical information as received;
the direct display unit is configured to display the preview contents on the lock screen interface when the lock screen interface is invoked.

12. The device according to claim 10, wherein, the preview displaying module comprises an information receiving unit, a content generating unit, an initial display unit and an indirect display unit,
the information receiving unit is configured to receive at least one of the text information, the graphics information, the expression information, the incoming call information and the geographical information;
the content generating unit is configured to generate the preview contents from the at least one of the text information, the graphics information, the expression information, the incoming call information and the geographical information as received;
the initial display unit is configured to display an icon or area corresponding to preview contents on the lock screen interface when the lock screen interface is invoked;
the indirect display unit is configured to display the preview contents when the operation conducted by the user on the icon or area is received.

13. The device according to claim 11, wherein, the content generating unit comprises a control creating subunit and a content generating subunit,
the control creating subunit is configured to create a list control as a preview control;
the content generating subunit is configured to successively load n contents as received into the preview control, wherein, n is an integer larger than or equal to 1;
the operation receiving module comprises an event detecting unit, an effectiveness judgment unit and an operation receiving unit;
the event detecting unit is configured to detect a slide event of the user on a certain content displayed in the preview control;
the effectiveness judgment unit is configured to determine whether a slide speed or a slide distance of the slide event is larger than a predetermined threshold;
the operation receiving unit is configured to determine that the operation conducted on the content is received if the effectiveness judgment unit determines that the slide speed or the slide distance of the slide event is larger than the predetermined threshold.

14. The device according to claim 9, wherein, the operation receiving module is configured to receive any of hand gestures comprising single-click, double-click and slide of the user on the preview contents.

15. The device according to claim 9, further comprising:
an distinguishingly displaying module configured to distinguishingly display or stop displaying the processed preview contents, wherein, the distinguishing display comprises at least one of display in a bold style, display in a dynamic effect, display in a changed font style, and display in a changed font size.

16. A storage medium containing one or more computer-executable instructions, wherein, the computer-executable instructions are configured to perform the quick operation device, the method includes the following steps of
displaying preview contents on a lock screen interface;
receiving an operation by a user on the preview contents;
processing the preview contents according to the operation, wherein, the process comprises marking the preview contents as read, or marking as at least one of the states of being collected, saved, deleted, reported, replied, played and updated.

17. The device of claim 16, wherein, the preview contents comprises at least one of text information, graphics information, expression information, incoming call information and geographical information.

18. The device of claim 16, wherein, the receiving an operation by a user on the preview contents comprises:
detecting a slide event of the user on a certain content displayed in the preview control;
determining whether a slide speed or a slide distance of the slide event is larger than a predetermined threshold; and
determining that the operation on the preview content is received if the slide speed or the slide distance is larger than the predetermined threshold.

19. The device of claim 16, wherein, the receiving an operation by a user on the preview contents comprises:
receiving any of hand gestures comprising single-click, double-click and slide of the user on the preview contents.

20. The device of claim 16, wherein, after processing the preview contents according to the operation, the method further comprises:
distinguishingly displaying or stopping displaying the processed preview contents, wherein, the distinguishing display comprises at least one of display in a bold style, display in a dynamic effect, display in a changed font style, and display in a changed font size.
